(19) United States
(12) Patent Application Publication
(10) Pub. No.: US 2024/0351160 A1
(43) Pub. Date: Oct. 24, 2024

(54) HAND-HELD POWER TOOL, AXIAL HOLDING ARRANGEMENT AND POLISHING PAD FOR SUCH A POWER TOOL

(71) Applicant: Andrea VALENTINI, Milano (IT)

(72) Inventor: Andrea VALENTINI, Milano (IT)

(21) Appl. No.: 18/632,448

(22) Filed: Apr. 11, 2024

(30) Foreign Application Priority Data
Apr. 19, 2023 (EP) 23 168 812.8

(51) Int. Cl. B24B 23/02; B24D 13/14

(52) U.S. Cl. CPC B24B 23/02; B24D 13/14

(57) ABSTRACT

The invention refers to power tool (10) comprising a tool housing (12), a motor (24) located therein and a tool shaft (36) with a rotational axis (40) and actuated by the motor (24) when in operation. A distal end of the tool shaft (36) is accessible from outside the tool housing (12). The power tool (10) further comprises a polishing pad (38) releasably attachable to the distal end of the tool shaft (36) from outside the tool housing (12) in an axial direction parallel to the rotational axis (40) and, after attachment to the tool shaft (36), held in respect to the tool shaft (36) in the axial direction by means of an axial holding arrangement (80). The axial holding arrangement (80) comprises a first element (36; 38) constituted by the polishing pad (38) or the tool shaft (36) and a second element (38; 36) constituted by the other one of the tool shaft (36) or the polishing pad (38), and at least one locking element (70) held in the first element (36; 38) movably in a radial direction between a retracted position and a locking position, at least one radially extending recess (76) provided in the second element (38; 36) and configured to receive part of the at least one locking element (70) when in its locking position. The locking elements (70) and the second element (38; 36) in and/or around the at least one radial recess (76) are made of a magnetic or ferromagnetic material so that the locking elements (70) are automatically held in their locking positions and in the at least one radial recess (76) by magnetic force.

### BACKGROUND OF THE INVENTION

### Field of Invention

The present invention refers to a hand-held power tool comprising a tool housing and a motor located therein and a tool shaft having a rotational axis, actuated by the motor when in operation in order to make the tool shaft perform a rotational movement about its rotational axis, a distal end of the tool shaft being accessible from outside the tool housing. The power tool further comprises a working element in the form of a polishing pad releasably attachable to the distal end of the tool shaft from outside the tool housing in an axial direction parallel to the rotational axis of the tool shaft and, after attachment to the tool shaft, held in respect to the tool shaft by means of an axial holding arrangement.

Further, the invention refers to an axial holding arrangement for holding a polishing pad of a hand-held power tool in respect to a tool shaft of the power tool in an axial direction extending parallel to a rotational axis of the tool shaft, after releasable attachment of the polishing pad to the tool shaft in the axial direction. Finally, the invention refers to a polishing pad of a hand-held power tool, the polishing pad configured for releasable attachment to a tool shaft of the power tool in an axial direction extending parallel to a rotational axis of the tool shaft and further configured to be held by an axial holding arrangement in the axial direction, after releasable attachment of the polishing to the tool shaft in the axial direction.

### Prior Art

In general, polishing pads of the above-mentioned kind comprise a plate-like supporting structure made of a rigid material like plastic and/or metal and having two opposing surfaces. The supporting structure may be made of a plastic material in which metal reinforcements are embedded, e.g., in the area of a fastening section by means of which the polishing pad can be removably attached to the tool shaft of a power tool. Attachment of the polishing pad to the tool shaft is designed such that a torque can be transmitted from the tool shaft to the polishing pad. The polishing pad attached to the tool shaft performs a rotational movement upon operation of the tool motor. A polishing member is fixedly attached to at least one of the two opposing surfaces of the supporting structure, for instance by means of gluing, welding or co-moulding. The polishing member may comprise an open- or closed-cell structure foam or sponge material, a natural or synthetic wool material, a microfibre material or the like.

The polishing pad may be a conventional single-sided polishing pad, where a fastening section for releasable attachment to the tool shaft is located centrally on a top surface of the supporting structure and the polishing member is fixedly attached to a bottom surface of the supporting structure. The fastening section may comprise a cylindrical pin protruding beyond the top surface, which may be inserted into a respective bore provided in a distal end of the tool shaft. Alternatively, the fastening section may comprise a recess or bore embedded in the top surface, in which a protruding element attached to the distal end of the tool shaft or making an integral part thereof may be inserted in an axial direction and then held in respect to the supporting structure and the polishing pad, respectively, in the axial direction by an axial holding arrangement.

Alternatively, the polishing pad may be a double-sided polishing pad, where the polishing member is attached to both of the two opposing surfaces of the supporting structure and the fastening section for releasable attachment to the tool shaft is located centrally on both of the two opposing surfaces. Preferably, the fastening section comprises recesses in which a protruding element attached to the distal end of the tool shaft or making an integral part thereof may be inserted in an axial direction and then held in respect to the supporting structure and the polishing pad, respectively, in the axial direction by an axial holding arrangement, so that the polishing pad may be releasably attached to the tool shaft from either of its two opposing sides.

Various designs of axial holding arrangements for holding a polishing pad in respect to a tool shaft in an axial direction extending essentially parallel to the rotational axis of the tool shaft, after releasable attachment of the polishing pad to a distal end of the tool shaft in the axial direction, are known in the art. For instance, the axial holding arrangement may comprise mechanical spring-loaded clamping members, as described in U.S. Pat. No. 6,640,377 B2, or magnetic elements realizing a magnetic force in the axial direction, as described in EP 3 892 419 A1. These prior art designs have in common that they comprise a large number of parts, are difficult to handle and/or that safety and reliability of the axial holding arrangements for holding the polishing pad in respect to the tool shaft in the axial direction are worthy of improvement.

### SUMMARY OF THE INVENTION

Therefore, it is an object of the present invention to provide for a hand-held power tool having an improved axial holding arrangement for holding a polishing pad of the power tool in respect to the tool shaft in the axial direction, which is easy and cheap to manufacture, easy and safe to handle or operate and which has an improved safety and reliability, in order to prevent unintentional detachment of the polishing pad from the tool shaft.

In order to solve the object of the present invention a hand-held power tool comprising the features of claim 1 is suggested. In particular, starting from the power tool of the above-identified kind, it is suggested that the axial holding arrangement comprises
a first element constituted by one of the following elements, the polishing pad and the tool shaft, and a second element constituted by the other one of the elements, the polishing pad and the tool shaft, and
at least one locking element assigned to the first element movably in a radial direction between a retracted position, in which the at least one locking element is retracted in the first element, and a locking position, in which the at least one locking element protrudes from the first element radially towards the second element,
at least one recess assigned to the second element and having a radial extension, the at least one radial recess being configured to receive part of the at least one locking element when in its locking position after releasable attachment of the polishing pad to the tool shaft,
wherein at least one of the following elements, the at least one locking element and the second element in and/or around the at least one radial recess, comprises a magnetic material, and the at least one other of the elements, the at least one locking element and the second element in and/or around the at least one radial recess, comprises a magnetic material or a ferromagnetic material, so that the at least one locking element is automatically moved and held in its locking position and in the at least one radial recess by means of magnetic force after attachment of the polishing pad to the tool shaft, thereby engaging with the at least one radial recess and holding the polishing pad in respect to the tool shaft in the axial direction.

When mentioning a plurality of locking elements hereinafter, it is always intended to refer to at least one locking element. An advantage of the present invention is that the locking elements automatically enter into engagement with the at least one radial recess once the polishing pad has been releasably attached to the tool shaft in the axial direction. The automatic entering into engagement is realized by means of magnetic force acting in an essentially radial direction between the locking elements and the respective at least one radial recess. Once the polishing pad has been releasably attached to the tool shaft in the axial direction, the locking elements are forced into their locking positions and into engagement with the respective at least one radial recess by means of magnetic force acting between the locking elements and the at least one recess and/or part of the second element surrounding the at least one radial recess.

The engagement of the locking elements with the at least one radial recess is preferably a mechanical engagement. The locking elements held in the first element mechanically engage with the at least one radial recess in the second element and prevent a relative axial movement between the first element and the second element. To this end, part of the locking elements remains in the first element and another part of the locking elements enters into the at least one radial recess.

It is suggested that one of 1) the at least one locking element and 2) at least part of the second element in a region of the at least one radial recess comprises a magnetic material. Similarly, the other one of 1) the at least one locking element and 2) at least part of the second element in a region of the at least one radial recess comprises a magnetic or a ferromagnetic material. Thus, a magnetic force acts between the locking elements and the second element in the region of the at least one radial recess, which automatically moves and holds the locking elements into their locking positions and in the at least one radial recess, once the polishing pad has been releasably attached to the tool shaft in the axial direction. With the locking elements in their locking positions, the polishing pad is held in the axial direction in respect to the tool shaft.

With other words, the following embodiments may be realized according to the present invention:
the one or more locking elements comprise or are made of a magnetic material and the second element in the region of the one or more radial recesses comprises or is made of a ferromagnetic material, e.g., iron, steel,
the one or more locking elements comprise or are made of a magnetic material and the second element in the region of the one or more radial recesses comprises or is made of a magnetic material having an opposite polarity than the magnetic material of the locking elements, and
the one or more locking elements comprise or are made of a ferromagnetic material, e.g., iron, steel, and the second element in the region of the one or more radial recesses comprises or is made of a magnetic material.

The locking elements may have an essentially spherical design. Alternatively, it is also contemplated that the one or more locking elements have an essentially cuboid form. Other forms of the locking elements are also possible.

One surface of the locking elements provided in the first element and facing the second element may be provided with tapered or rounded edges. Similarly, a circumferential edge limiting a hole opening into the at least one radial recess may have a tapered or rounded edge. Preferably, seen along the rotational axis of the tool shaft, the tapered or rounded edges are provided on two opposite sides of the surface or hole along the rotational axis. This facilitates a movement of the locking elements from their locking positions into their retracted positions when the polishing pad is to be detached and removed from the tool shaft. A user of the power tool may grasp the polishing pad with his hand and pull it in an axial direction away from the power tool housing. This axial movement will urge the locking elements to move radially from their locking positions into their retracted positions thereby overcoming the magnetic force. The tapered or rounded edges delimiting the surfaces of the locking elements facing the second element and/or delimiting a hole opening into the at least one recess will redirect the axial movement into the radial movement of the locking elements into their retracted positions.

In particular, due to the specific design of the tapered or rounded form of the edges of the locking elements and/or the hole(s) opening into the one or more radial recesses, a detachment movement of the polishing pad from the tool shaft parallel to the rotational axis of the tool shaft, automatically leads to a disengagement of the locking elements and the respective one or more radial recesses, while overcoming the radially acting magnetic force. With other words, the axial movement of the polishing pad in respect to the tool shaft is automatically and more easily translated into a radial movement of the locking elements from their locking positions into their retracted positions.

In the case of spherically shaped locking elements, a surface of each locking element facing the second element, has rounded edges anyway. In the case of cuboid-shaped locking elements, a rectangular surface of each locking element facing the second element, could have opposite top and bottom tapered or rounded edges, seen along the rotational axis of the tool shaft.

The polishing pad (also called polishing disc or polishing plate) may have different designs. Preferably, in a top or bottom view, the polishing pad has a circular shape and two opposing sides. A first type of polishing pad may be configured as a single-sided polishing pad releasably attachable to the tool shaft with its top side only, while the bottom side has a polishing member and serves for polishing a workpiece. An alternative type of polishing pad may be configured as a double-sided polishing pad releasably attachable to the tool shaft with either of its opposing sides, which at the same time both may have a polishing member and both serve for polishing a workpiece. That side of the double-sided polishing pad opposite to the side with which the polishing pad is currently attached to the tool shaft, is used for polishing the workpiece. Releasable attachment of the polishing pad is preferably achieved from outside the tool housing in an axial direction parallel to the rotational axis of the tool shaft.

The polishing pads may comprise a plate-like supporting structure made of a rigid material like plastic and/or metal and having two opposing surfaces. The support structure may have a flat and essentially circular form. It may be provided with reinforcement ribs, recesses and holes or the like for structural reinforcement and rigidity. The supporting structure may be made of a plastic material. Metal reinforcements may be embedded into the plastic material, e.g., in the area of a fastening section by means of which the polishing pad can be attached to the tool shaft of a power tool. Attachment of the polishing pad to the tool shaft is such that a torque of the tool shaft can be transmitted from the tool shaft to the polishing pad during rotation about the rotational axis of the tool shaft.

A polishing member is fixedly attached to at least one of the two opposing surfaces of the supporting structure, for instance by means of gluing, welding or co-moulding. The polishing member may comprise an open- or closed-cell structure foam or sponge material, a natural or synthetic wool material, a microfibre material or the like. The polishing member may extend beyond the lateral circumferential surface of the support structure, thereby preventing damage of a surface to be polished (e.g., a vehicle body, a boat hull or an airplane fuselage, a furniture, a music instrument, a glass ceramic cook top or the like) by the rigid support structure during intended use of the power tool.

In a conventional single-sided polishing pad, the fastening section for releasable attachment to the tool shaft is located on a top surface of the two opposing surfaces of the support structure. The polishing member is fixedly attached to an opposite bottom surface. The fastening section may comprise a protruding cylindrical pin which it may be axially inserted into and fastened to a respective bore provided in a distal end of the tool shaft. Alternatively, the fastening section may comprise a recess or bore in which a protruding element attached to the distal end of the tool shaft or forming an integral part thereof may be axially inserted and fastened. Fastening of the polishing pad to the tool shaft, i.e., holding of the polishing pad in the axial direction in respect to the tool shaft, is achieved by the axial holding arrangement according to the present invention.

Alternatively, the polishing pad may be a double-sided polishing pad, where the same or different polishing members are fixedly attached to both of the two opposing surfaces of the support structure and a fastening section for releasable attachment to the tool shaft is located centrally on and accessible from both of the two opposing surfaces. Different polishing members may differ, e.g., by the type of material used (foamed plastic material, wool, microfibre), by the properties of the material (hardness, cell structure in the case of foamed material, length or diameter of wool or microfibres), the colour of the material or in other ways. The double-sided polishing pad can be attached to the tool shaft from either side. Preferably, the fastening section comprises recesses or bores in which a protruding element attached to the tool shaft of forming an integral part thereof may be inserted and held in the axial direction. Fastening of the polishing pad to the tool shaft, i.e., holding of the polishing pad in the axial direction in respect to the tool shaft, is achieved by the axial holding arrangement according to the present invention.

According to a preferred embodiment of the invention, it is suggested that the first element is the tool shaft and the second element is the polishing pad. Thus, in this embodiment, the tool shaft comprises the radially movable locking elements and the polishing pad or a fastening section thereof, respectively, comprises the at least one radial recess.

Depending on the design of the tool shaft and the polishing pad, the locking elements move radially outwards or radially inwards into their locking positions. If the tool shaft comprises a cylindrical pin for insertion into an axial recess or bore provided in the polishing pad, i.e., in a fastening section of the polishing pad, the locking elements will move radially outwards into their locking positions beyond an external circumferential surface of the cylindrical pin. If the tool shaft comprises an axial bore at its distal end for receiving a cylindrical pin of the polishing pad, the locking elements will move radially inwards into their locking positions beyond an internal circumferential surface of the bore.

Similarly, the at least one radial recess may be provided in an external circumferential surface of a cylindrical pin of the second element or in an internal circumferential surface of an axial recess or bore of the second element.

According to another preferred embodiment of the invention, it is suggested that the first element is the polishing pad and the second element is the tool shaft. Thus, in this embodiment, the polishing pad comprises the locking elements in a radially movable manner and the tool shaft is provided with the at least one radial recess.

Depending on the design of the tool shaft and the polishing pad, the locking elements move radially outwards or radially inwards into their locking positions. If the polishing pad is provided with an axial bore for receiving a cylindrical pin of the tool shaft, the locking elements will move radially inwards into their locking positions. If the polishing pad comprises a cylindrical pin for insertion into an axial bore of the tool shaft, the locking elements will move radially outwards into their locking positions.

Similarly, the at least one radial recess may be provided on an external or an internal circumferential surface of the tool shaft. If the tool shaft is provided with a cylindrical pin, the at least one recess will be provided on an external circumferential surface of the pin. Alternatively, if the tool shaft is provided with an axial bore in its distal end, the at least one recess will be provided on an internal circumferential surface of the bore.

According to a preferred embodiment of the invention, it is suggested that the first element has an axial bore and the locking elements are held in a hollow cylindrical jacket radially delimiting the bore. In that case, the locking elements would move radially inwards towards the rotational axis of the tool shaft into their locking positions. Correspondingly, it is suggested that the second element has a cylindrical pin and the at least one radial recess is provided on an external circumferential surface of the pin.

Preferably, a distal end of the cylindrical pin has a tapered or rounded surface in order to more easily and automatically push the locking elements radially outwards into their retracted positions during insertion of the cylindrical pin into an axial bore. Additionally or alternatively, an outer circumferential edge delimiting an entry hole opening into an axial bore has a tapered or rounded surface in order to facilitate insertion of the cylindrical pin into the axial bore.

It is suggested that the axial bore and the cylindrical pin each have an axially extending section with a corresponding cross-sectional surface without a rotational symmetry, the sections configured to mechanically engage with each other after releasable attachment of the polishing pad to the tool shaft and after insertion of the cylindrical pin into the axial bore, thereby permitting the transmission of torque from the tool shaft to the polishing pad during operation of the motor of the power tool. It is suggested that the non-rotationally symmetric cross-sectional surface has the form of a polygon, e.g., a triangle, a square, a pentagon, a hexagon, an octagon or the like, preferably with equal side lengths.

To this end, it is preferred that no or only a very small amount of torque about the rotational axis of the tool shaft is transmitted from the tool shaft to the polishing pad across the axial holding arrangement, in particular the locking elements. Most part of the torque is transmitted across the corresponding axially extending sections with the non-rotationally symmetric cross-sectional surface. This significantly increases durability and strength of the axial holding arrangement and, thus, of the entire power tool. When attaching the polishing pad to the tool shaft, the corresponding sections with the non-rotationally symmetric cross-sectional surfaces automatically enter into engagement with each other and allow transmission of torque.

Furthermore, it is suggested that the locking elements and the at least one radial recess are correspondingly shaped at least in those sections with which they enter into engagement with each other in the locking position of the locking elements. This provides for a safe and reliable reception of the locking elements in the respective at least one radial recess in the locking positions of the locking elements and to a backlash-free engagement of the locking elements in the at least one recess without mechanical play that could lead to a rattling noise or the like during intended use of the power tool.

According to a preferred embodiment of the invention, a plurality of locking elements is equidistantly positioned in a circumferential direction about the rotational axis of the tool shaft, when the polishing pad is attached to the tool shaft. Further, it is suggested that the axial holding arrangement comprises at least two, preferably at least three, particularly preferred at least four locking elements.

According to an embodiment of the invention, the axial holding arrangement comprises the same number of one or more radial recesses as there are locking elements provided in the axial holding arrangement. Alternatively, the axial holding arrangement comprises a single annularly shaped radial recess configured to receive the one or all of the locking elements.

Further features and advantages of the present invention will become apparent from the embodiments described hereinafter with reference to one or more of the accompanying drawings. It is emphasized that each of the features shown in the figures and possibly described hereinafter with reference to a certain embodiment may be important to the invention on its own or in the context of another embodiment even if not explicitly shown in the figures and/or described in the subsequent description.

### BRIEF DESCRIPTION OF THE DRAWING

The drawing includes FIGS. 1-9, which show:

FIG. 1 a side view of a power tool according to the present invention in a preferred embodiment;

FIG. 2 a top view of the power tool of FIG. 1;

FIG. 3 an enlarged view of a tool shaft of a power tool and a first type of polishing pad having a first type of fastening section configured to be releasably attached and held in respect to the tool shaft in an axial direction by means of an axial holding arrangement according to the present invention;

FIG. 4 an enlarged view of a tool shaft of a power tool and the first type of fastening section of a polishing pad configured to be releasably attached and held in respect to the tool shaft in an axial direction by means of an axial holding arrangement according to the present invention in a first embodiment;

FIG. 5 an enlarged view of a tool shaft of a power tool and the first type of fastening section of a polishing pad configured to be releasably attached and held in respect to the tool shaft in an axial direction by means of an axial holding arrangement according to the present invention in a second embodiment;

FIG. 6 an enlarged view of a tool shaft of a power tool and a first type of polishing pad having a second type of fastening section configured to be releasably attached and held in respect to the tool shaft in an axial direction by means of an axial holding arrangement according to the present invention,

FIG. 7 an enlarged view of a tool shaft of a power tool and the second type of fastening section of a polishing pad configured to be releasably attached and held in respect to the tool shaft in an axial direction by means of an axial holding arrangement according to the present invention in a third embodiment,

FIG. 8 an enlarged view of a tool shaft of a power tool and the second type of fastening section of a polishing pad configured to be releasably attached and held in respect to the tool shaft in an axial direction by means of an axial holding arrangement according to the present invention in a fourth embodiment, and

FIG. 9 an enlarged view of a tool shaft of a power tool and a second type of polishing pad configured to be releasably attached and held in respect to the tool shaft in an axial direction by means of an axial holding arrangement according to the present invention in a fifth embodiment.

### DETAILED DESCRIPTION OF THE INVENTION

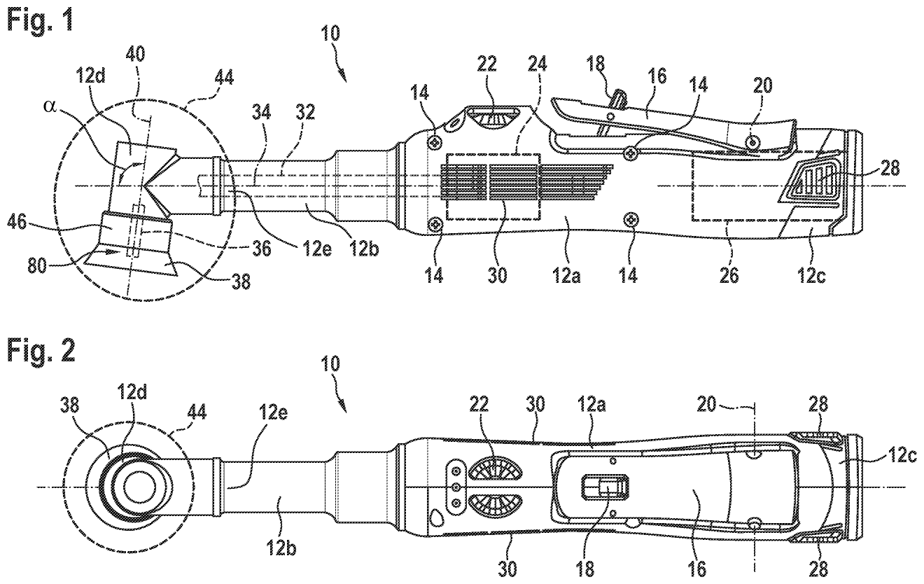

FIGS. 1 and 2 show a side view and a top view, respectively, of a hand held and/or hand guided power tool 10 embodied as a polishing machine or as a polisher. Alternatively, the power tool 10 according to the present invention could also be embodied as a sander or a grinder, or even as a drill, a cordless screw driver, or a mixer, only to mention a few examples.

The polisher 10 comprises a housing 12 made up of essentially two main parts, a rear part 12a and a front part 12b. In more detail the housing 2 comprises the rear part 12a, a distal end part 12c, the front part 12b and a front casing 12d. The rear part 12a is preferably made of a rigid plastics material. Of course, the rear part 12a of the housing 12 could also be made of a different rigid material, for example metal or carbon fibre. Further, the rear part 12a of the housing 12 could comprise regions provided with resilient material like a soft plastic material or rubber in order to ensure safe and comfortable gripping, holding and guiding of the power tool 10 by a user. The rear part 12a of the housing 12 is preferably divided by means of an essentially vertical plain into two half shells which are attached on one another along the vertical plane and held together by screws 14.

The rear part 12a of the housing 12 comprises an actuation lever 16 co-operating with a switch, preferably located inside the housing 12, for turning on and off the polisher 10. The actuation lever 4 may comprise a blocking mechanism 18 for avoiding unintentional activation of the tool 10. The actuation lever 16 is rotatable about a rotational axis 20 extending perpendicular in respect to a longitudinal extension of the housing 12. In the embodiment shown in FIGS. 1 and 2, the actuation lever 16 is located on a top side of the housing 12. Of course, it would also be possible to locate the lever 16 on a bottom side of the housing 12 (not shown). It is also conceivable, to use one or more push buttons or a rotary switch instead of the lever 16 to actuate the power tool 10.

Furthermore, in the embodiment of FIGS. 1 and 2 the rear part 12a of the housing 12 is provided with a turn wheel 22 for speed regulation of a tool's motor 24. The rotary wheel 22 may co-operate with a potentiometer, preferably located inside the housing 12. Of course, it is also conceivable, to provide the actuation lever 16 or the one or more push buttons or the rotary switch with a speed regulation functionality. In that case the turn wheel 22 could be omitted.

A distal rear end 12c of the rear part 12a can be removed from the rest of the housing 12 in order to withdraw a battery 26 from the inside of the rear part 12a of the housing 12. The battery 26 provides the polisher 10 and its electronic components, respectively, with electric energy necessary for their operation. Of course, the polisher 10 could also be operated with electric energy from a mains power supply. In that case the battery 26 would not be necessary and the receptacle for the battery 26 in the housing 12 could be used for accommodating a transformer and other electric circuitry for transforming the mains voltage (e.g., 100V or 250V AC and 50 Hz or 60 Hz) into an operating voltage (e.g., 12V, 18V, or 24V DC) for the electronic components of the polisher 10.

The distal end 12c of the housing 12 may be secured to the rear part 12a by means of a snap-action connection comprising two opposite lateral snap-releasing knobs 28 for releasing the snap-action connection. For removing the distal rear end 12c from the rear part 12a of the housing 2, the lateral snap-releasing knobs 28 are pressed, thereby releasing the snap-action connection and allowing separation of the distal end 12c of the housing 12 from the rear part 12a and withdrawal of the battery 26 from the housing 12. The distal end 12c of the housing 12 may be attached to the battery 26 or it may be in the form of a separate lid for closing the receptacle for the battery 26 independently.

The rear part 12a of the housing 12 may be provided with a plurality of cooling vents 30 of any desired shape and extension enabling an airstream from the inside of the housing 12 into the environment and cooling of the electronic components located inside the housing 12 during operation of the power tool 10.

The front part 12b of the housing 12 is essentially tube-shaped and serves for receiving and guiding a driving shaft 32, e.g., by means of one or more bearings (not shown), during its rotation about a rotational axis 34. The driving shaft 32 is driven by the motor 24. To this end, the driving shaft 32 may form an integral part with a motor shaft or may be attached thereto. The tube-shaped front part 12b is preferably made of a metal, e.g., Aluminium, or a rigid plastic material. The front part 12b may be releasably attached to the rear part 12a of the housing 12, e.g., by means of a threaded connection or by screws. It is also conceivable to simply sandwich a rear end of the front part 12b between the two half shells which form the rear part 12a of the housing 12. By fixing the two half shells together, e.g., by means of the screws 14, the front part 12b may be held and fixed in respect to the rear part 12a of the housing 12. Alternatively, the front part 12b forms an integral part with the rear part 12a. In particular, it is conceivable that the front part 12b also comprises two half shells which each may form in integral part with the respective half shells of the rear part 12a of the housing 12.

Located inside the rear part 12a of the housing 12 is the electric motor 24, which is preferably embodied as a brushless (BL) motor, in particular a BL direct current (BLDC) motor. Furthermore, located between the motor shaft and the driving shaft 32, there may be a first gear mechanism (not shown) which can set a certain transmission ratio between the rotational speed of the motor shaft and the rotational speed of the driving shaft 32. Depending on the design of the gear mechanism, the ratio can be 1, larger than 1 or smaller than 1. Usually, the ratio will be larger than 1 because the motor shaft rotates faster than the driving shaft 32.

The power tool 10 may comprise a second gear mechanism, which may be provided for translating the rotational movement of the driving shaft 32 about the rotational axis 34 into a rotational movement of a tool shaft 36 of the power tool 10 about a further rotational axis 40. The tool shaft 36 actuates a polishing pad 38 (or polishing disc or polishing plate) of the power tool 10, the polishing pad 38 being attached to the tool shaft 36 in an axial direction and held to the tool shaft 36 by means of an axial holding arrangement 80 according to the present invention, which will be described in further detail below. The two rotational axes 34, 40 intersect at a certain angle α between approximately 70° and 110°, in particular around 90°. In the embodiment of FIGS. 1 and 2, the angle α of the two rotational axes 34, 40 is approximately 98°.

A front end of the driving shaft 32, the second gear mechanism and the tool shaft 36 are preferably located in a tool head 44 which is attached to a front end 12e of the front part 12b of the tool housing 12. The tool head 44 preferably comprises a tube-like front casing 12d which serves for receiving and guiding the tool shaft 36, e.g., by means of one or more bearings (not shown), during its rotation about the rotational axis 40. The tool head 44 is preferably an integral part of the front part 12b of the housing 12. It is preferably made of the same material as the tube-like front part 12b. The second gear mechanism is preferably located inside the tube-like front casing 12d. A protective shroud 46 is attached to a bottom end of the tube-like front casing 12d surrounding at least part of the tool shaft 36 preferably protruding beyond the front casing 12d.

The second gear mechanism may comprise a bevel gear arrangement with two meshing bevel gear wheels. One bevel gear wheel may be attached to the driving shaft 32 or form an integral part thereof. The other bevel gear wheel may be attached to the tool shaft 36 or form an integral part thereof. The bevel gear arrangement could comprise a transmission ratio of larger than 1, smaller than 1 or equal to 1.

In contrast to what has been described above, the first and second gear mechanism could also be designed as a single gear mechanism located between the motor shaft and the driving shaft 32 or in the tool head 44. In that case, the single gear mechanism preferably has a transmission ration of #1. Alternatively, the power tool 10 according to the present invention may also comprise no gear mechanism at all, in which case the tool shaft 36 would rotate about the same rotational axis as the motor shaft and—if present—the driving shaft 32.

Furthermore, a printed circuit board (PCB) comprising electric and electronic circuitry and components which together form at least part of a control unit may be located inside the housing 12. Preferably, the control unit comprises a microcontroller and/or a microprocessor for processing a computer program which is programmed to perform the desired motor control function, when it is processed on the microprocessor.

In contrast to what has been described above, the power tool 10 could also be equipped with a pneumatic motor instead of the electric motor 24. In that case, pressurized air could be fed to the power tool 10 through an air inlet and led to the pneumatic motor.

Generally speaking, according to the present invention, a first element of the axial holding arrangement 80 is defined, which is constituted by the polishing pad 38 or the tool shaft 36, and a second element is defined, which is constituted by the other one of the two elements, i.e., the tool shaft 36 or the working element 38. At least one locking element 70 is assigned to the first element 36; 38. The locking element 70 is movable in respect to the first element 36; 38 in a radial direction between a retracted position, in which the at least one locking element 70 is retracted in the first element 36; 38, and a locking position, in which the at least one locking element 70 protrudes from the first element 36; 38 radially towards the second element 38; 36. At least one recess 76 with a radial extension is assigned to the second element 38; 36. The at least one radial recess 76 is configured to receive part of the at least one locking element 70 when in its locking position after attachment of the working element 38 to the tool shaft 36. At least one of the following elements, the at least one locking element 70 and the second element 38; 36 in and/or around the at least one radial recess 76, comprises or is made of a magnetic material and the at least other one of the two elements, the second element 38; 36 in and/or around the at least one radial recess 76 and the at least one locking element 70, comprises or is made of a magnetic material or a ferromagnetic material. The at least one locking element 70 is automatically moved into and held in its locking position by means of magnetic force. After attachment of the working element 38 to the tool shaft 36 in the axial direction, the at least one locking element 70 is moved into the at least one radial recess 76 and held therein by means of magnetic force. With other words, due to the at least one locking element 70 engaging with the at least one radial recess 76, the working element 38 is held in respect to the tool shaft 36 in the axial direction. Attachment of the working element 38 to the tool shaft 36 is preferably torque proof such that a torque can be transmitted form the tool shaft 36 to the polishing pad 38.

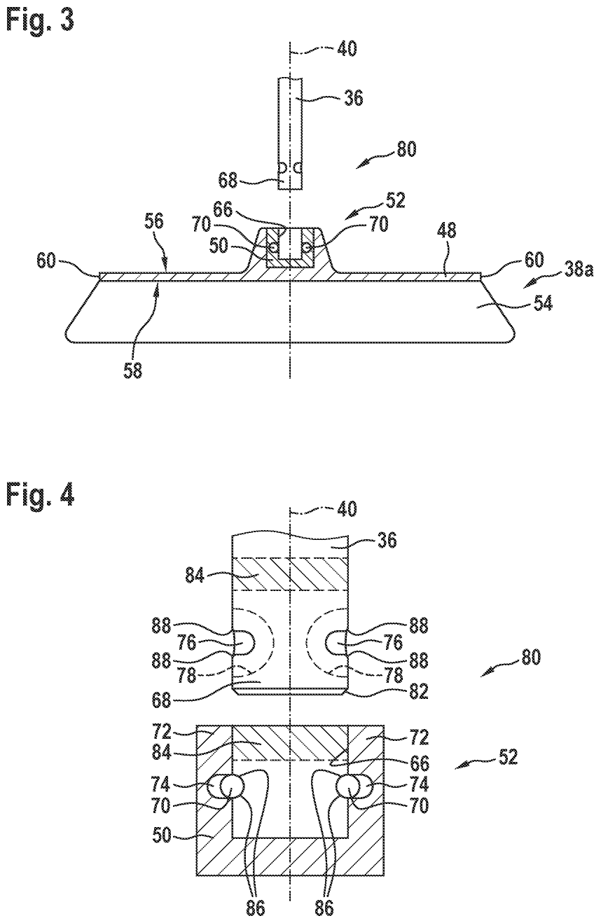

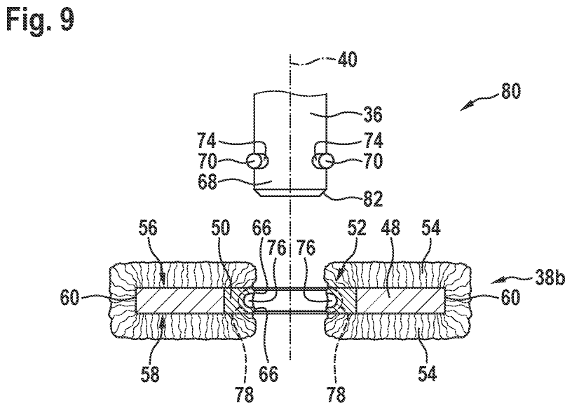

As can be seen in FIGS. 3, 6 and 9, the polishing pad 38 may have different designs. Preferably, in a top or bottom view, the polishing pad 38 has a circular shape with two opposing sides. A first type of polishing pad 38 (see FIGS. 3 and 6) may be configured as a single-sided polishing pad 38a releasably attachable to the tool shaft 36 with one of its sides only. Attachment is achieved from outside the tool housing 12 in an axial direction parallel to the rotational axis 10 of the tool shaft 36. An alternative type of polishing pad 38 (see FIG. 9) may be configured as a double-sided polishing pad 38b releasably attachable to the tool shaft 36 with either of its sides from outside the tool housing 12 in an axial direction parallel to the rotational axis 40 of the tool shaft 36.

The polishing pads 38 may comprise a plate-like supporting structure 48 made of a rigid material like plastic and/or metal and having two opposing surfaces 56, 58. The support structure 48 may have a flat and essentially circular form. It may be provided with reinforcement ribs, recesses and holes extending along its flat extension for structural reinforcement. In the embodiments shown, the supporting structure 48 is made of a plastic material. Reinforcements 50, for example made of metal, may be embedded into the plastic material, e.g., in the area of a fastening section 52, by means of which the polishing pad 38 can be attached to the tool shaft 36 of a power tool 10. Attachment of the polishing pad 38 to the tool shaft 36 is designed such that a torque about the rotational axis 40 of the tool shaft 36 can be transmitted from the tool shaft 36 to the polishing pad 38. To this end, the polishing pad 38 preferably performs a rotational movement about the rotational axis 40 during intended use of the power tool 10. Of course, with other tools 10, the polishing pad 38 could perform other types of movements as well, e.g., a random-orbital, an eccentric or a gear-driven movement.

A polishing member 54 is fixedly attached to at least one of the two opposing surfaces 56, 58 of the supporting structure 48, for instance by means of gluing or co-moulding. The polishing member 54 may comprise an open- or closed-cell structure foam or sponge material (see FIGS. 3 and 6), a natural or synthetic wool material (see FIG. 9), a microfibre material or the like. The polishing member 54 may extend beyond the lateral circumferential surface 60 of the support structure 48, thereby preventing damage of a surface to be polished (e.g., a vehicle body, a boat hull or an airplane fuselage, a furniture, a music instrument, a glass ceramic cook top or the like) by the rigid support structure 48 during intended use of the power tool 10.

As shown in FIGS. 3 and 6, in a conventional single-sided polishing pad 38a, the fastening section 52 for releasable attachment to the tool shaft 36 is located on a top surface 56 of the two opposing surfaces 56, 58 of the support structure 48. The polishing member 54 is attached to a bottom surface 58 of the two opposing surfaces 56, 58. The fastening section 52 may comprise a protruding cylindrical pin 62 (see FIG. 6) which may be axially inserted and held in a respective axially extending recess or bore 64 provided in a distal end of the tool shaft 36. Alternatively, as shown in FIG. 3, the fastening section 52 may comprise an axially extending recess or bore 66 in which a protruding element 68 attached to the distal end of the tool shaft 36 and constituting an integral part thereof may be axially inserted and held. The axial recess or bore 66 is preferably designed in the reinforcement 50 of the fastening section 52. Holding of the polishing pad 38a in respect to the tool shaft 36 in the axial direction is achieved by the axial holding arrangement 80 according to the present invention.

Alternatively, as shown in FIG. 9, the polishing pad 38 may be a double-sided polishing pad 38b, where a polishing member 54 is attached to both of the two opposing surfaces 56, 58 of the support structure 48. The polishing members 54 attached to each of the two surfaces 56, 58 may differ from each other, e.g., by the type of material used (foamed plastic material, wool, microfibre), by the properties of the material (hardness, cell structure in the case of foamed material, length or diameter of wool or microfibres), the colour of the material or in other ways. The fastening section 52 for releasable attachment to the tool shaft 36 is located centrally on and accessible from both of the two opposing surfaces 56, 58. Preferably, the fastening section 52 comprises recesses or bores 66 in which a protruding element 68 attached to the distal end of the tool shaft 36 or constituting an integral part thereof may be inserted and fastened, so that the polishing pad 38b may be releasably attached to the tool shaft 36 from either side. Holding of the polishing pad 38b in respect to the tool shaft 36 in the axial direction is achieved by the axial holding arrangement 80 according to the present invention.

In the embodiment of FIG. 9, the fastening section 52 comprises a single through bore constituted by the two recesses or bores 66, into which the protruding element 68 of the tool shaft 36 may enter from both sides thereby using the same axial holding arrangement 80 from both sides. Obviously, the polishing pad 38b could also comprise two separate axial holding arrangements 80 in the two recesses or bores 66.

Hereinafter, the holding arrangement 80 according to the present invention is described in more detail with reference to FIGS. 4, 5, 7 and 8. According to a first embodiment, shown in FIG. 4, the fastening section 52 of the polishing pad 38 comprises a recess or bore 66 for receiving a protruding element 68 of the tool shaft 36. Locking elements 70 are assigned or associated to the polishing pad 38 and held in its fastening section 52 in a manner movable in a radial direction between a retracted position (see FIG. 3), in which the locking elements 70 are retracted in the polishing pad 38 or its fastening section 52, respectively, and a locking position (see FIG. 4), in which the locking elements 70 protrude from the polishing pad 38 or its fastening section 52, respectively, radially towards the tool shaft 36.

In particular, the locking elements 70 are held in a hollow cylindrical jacket 72 radially delimiting the recess or bore 66. To this end, it is suggested that receiving and guiding channels 74, preferably extending in a radial direction, are provided in the hollow jacket 72, configured to receive and hold one locking element 70 each. Preferably, after insertion of the locking elements 70 in the respective channels 74, an opening of the channels is closed such that on the one hand an unintentional falling out of the locking elements 70 is prevented and on the other hand the locking elements 70 may still move into their locking positions thereby protruding radially inwards towards the rotational axis 40 and beyond an internal circumferential surface radially delimiting the recess or bore 66.

Furthermore, one or more radial recesses 76 are assigned or associated to the tool shaft 36. In particular, the one or more recesses 76 are provided in an external circumferential surface of the protruding element 68 of the tool shaft 36. The radial recesses 76 are configured to receive part of the locking elements 70 when in their locking positions and when the polishing pad 38 is attached to the tool shaft 36 in the axial direction, i.e., when the protruding element 68 of the tool shaft 36 is inserted into the axial recess or bore 66 of the polishing pad 38.

Preferably, the axial holding arrangement 80 comprises at least two, preferably at least three, locking elements 70. It is further preferred that the locking elements 70 are equidistantly positioned in a circumferential direction about the rotational axis 40 of the tool shaft 36, when the polishing pad 38 is attached to the tool shaft 36. Further preferred, the axial holding arrangement 80 comprises the same number of radial recesses 76 as there are locking elements 70 provided in the axial holding arrangement 80. Alternatively, the axial holding arrangement 80 may comprise a single annularly shaped radial recess 76 configured to receive all the locking elements 70 in their locking positions.

In the retracted position of the locking elements 70, the protruding element 68 of the tool shaft 36 may be inserted into the recess or bore 66, thereby attaching the tool shaft 36 to the polishing pad 38. With the tool shaft 36 attached to the polishing pad 38, the locking elements 70 may move back into their locking positions and enter into mechanical engagement with the one or more respective recesses 76, thereby holding the polishing pad 38 in respect to the tool shaft 36 in the axial direction. Movement of the locking elements 70 into their locking positions and holding of the locking elements 70 there is achieved by means of magnetic force.

It is suggested that at least one of the locking elements 70 or the tool shaft 36, at least in a region 78 in and/or around the radial recesses 76, is made of a magnetic material. The other one of the locking elements 70 or the tool shaft 36, at least in the region 78 in and/or around the radial recesses 76, is made of a magnetic material or a ferromagnetic material. As a consequence, after attachment of the polishing pad 38 to the tool shaft 36, the locking elements 70 are automatically moved and held in their locking positions and in the radial recesses 76, thereby mechanically engaging with the radial recesses 76, by means of magnetic force, thereby holding the polishing pad 38 in respect to the tool shaft 36 in the axial direction.

During insertion of the protruding element 68 of the tool shaft 36 into the recess or bore 66 of the fastening section 52 of the polishing pad 38 in the axial direction, the protruding element 68 urges the locking elements 70 radially outwards in their channels 74. Then, when the locking elements 70 are aligned with the one or more recesses 76, the magnetic force acting between the locking elements 70 and the recesses 76 makes the locking elements 70 move towards and enter into the recesses 76, thereby providing for an axial holding of the polishing pad 38 in respect to the tool shaft 36.

It is further preferred that the locking elements 70 are made of or comprise a magnetic material whereas at least the region 78 surrounding the recesses 76, preferably the entire protruding element 68, particularly preferred the entire tool shaft 36 is made of or comprises a ferromagnetic material, preferably a metal, particularly preferred steel. Other possible ferromagnetic materials are iron, cobalt or nickel. Preferably, the reinforcement 50 of the support structure 48, which holds the locking elements 70, is made of or comprises only not magnetizable material. Such materials are, for example, plastic, aluminium, copper, lead, tin, titanium, and zinc.

The locking elements 70 are magnetically attracted by each other even if the polishing pad 38 is not attached to the tool shaft 36 and removed in an axial direction, i.e., when the tool shaft 36 is not inserted into the axial bore 66. The locking elements 70 are preferably held in their respective channels 74 so they cannot fall out into the axial bore 66 of the polishing pad 38, when the polishing pad 38 and the tool shaft 36 are separated from each other. However, during an intensive use of the power tool 10 and the polishing pad 38, respectively, the channels 74 may wear out to different degrees even up to the extent that one or more of the locking elements 70 is no longer properly held in its respective channel 74 when the polishing pad 38 and the tool shaft 36 are separated. Due to the magnetic attraction among the locking elements 70, the one or more locking elements 70, which is no longer properly held in its channel 74, is prevented from falling out of axial bore 66. Rather, the one or more locking elements 70, which is no longer properly held in its channel 74, is held in the axial direction by the one or more other locking elements 70, which are still properly held in their channel(s) 74. Upon insertion of the tool shaft 36 into the axial bore 66 in the axial direction, the locking elements 70, including the one or more locking elements 70, which is no longer properly held in its channel 74, are urged back into their respective holding and guiding channels 74 into their retracted positions.

This also prevents that the one or more locking elements 70, which is no longer properly held in its holding and guiding channel 74, is pushed towards the bottom of the axial bore 66 by means of the protruding element 68 when the polishing pad 38 is attached to the tool shaft 36, i.e., when the tool shaft 36 is inserted into the axial bore 66. To this end, it is particularly advantageous if a distal end surface 82 of the protruding element 68, which is inserted into the axial bore 66 during attachment of the polishing pad 38 to the tool shaft 36, has a tapered, a rounded, e.g., spherical, or a conical form or the form of a truncated cone, in order to better translate the axial movement of the tool shaft 36 into the radial movement of the locking elements 70 into their retracted positions. As shown in FIG. 4, the distal end surface 82 of the tool shaft 36 may comprise a tapered annular edge.

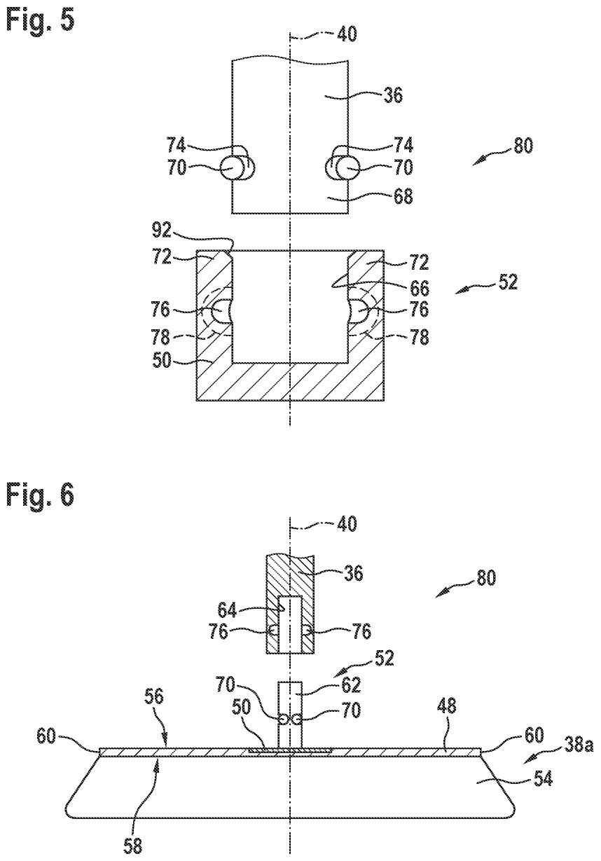

Alternatively or additionally, it is suggested that an outer edge delimiting an entry hole into the axially extending recess or bore 64, 66 has a tapered or a rounded surface 92 (see FIGS. 5 and 8). This facilitates insertion of the tool shaft 36 or of a cylindrical pin 62 of the polishing pad 38 into the recess or bore 64, 66.

Furthermore, it is emphasized that the present invention and in particular the magnetic axial holding arrangement 80 would work perfectly well even if the tool shaft 36 was not made of a magnetic or ferromagnetic material. For instance, in the embodiment of FIG. 4, the protruding element 68 having the radial recesses 76 or even the entire tool shaft 36, respectively, could be made of plastic, aluminium or the like non ferromagnetic material. The locking elements 70 made of magnetic material would still be mutually magnetically attracted by each other in the radial direction towards the rotational axis 40 and, thus, held in their respective radial recess(es) 76. Of course, in that case the locking elements 70 would preferably be made of a stronger magnetic material in order to create larger magnetic forces between the locking elements 70.

In order to transmit a torque from the tool shaft 36 to the polishing pad 38, it is suggested that the axial bore 66 and the protruding element 68 each have an axially extending section 84 (see FIG. 4) with a corresponding non-rotational cross-sectional surface. The sections 84 are configured to mechanically engage with each other when the polishing pad 38 is attached to the tool shaft 36 in the axial direction, i.e., when the tool shaft 36 is inserted into the axial bore 66, thereby permitting the transmission of torque from the tool shaft 36 to the polishing pad 38 during operation of the motor 24 of the power tool 10. The non-rotational cross-sectional surface may have an oval form, the form of a triangle, a square or any other type of polygon, preferably having equal side lengths. Such axially extending sections 84 assigned to the tool shaft 36 and the polishing pad 38 are preferably provided in all of the embodiments shown and described herein, even if not explicitly mentioned and/or shown.

In order to facilitate attachment and release of the polishing pad 38 to/from the tool shaft 36, it is suggested that a distal end of the radially movable locking elements 70 facing the radially extending recess 76, when the polishing pad 38 is attached to the tool shaft 36, has a tapered or a rounded surface 86 (see FIG. 4), in order to better translate the axial insertion movement of the tool shaft 36 into the radial movement of the locking elements 70 into their retracted positions. Alternatively or additionally, an outer edge delimiting an entry hole into the radially extending recesses 76 facing the radially movable locking elements 70, when the polishing pad 38 is attached to the tool shaft 36, has a tapered or a rounded surface 88.

It is suggested that the locking elements 70 and the radial recesses 76 are correspondingly shaped at least in those sections with which they mechanically engage with each other in the locking position of the locking elements 70. In fact, it can be seen in FIG. 4 that the recesses 76 have the form of a hemisphere.

In the embodiments shown, the locking elements 70 have a spherical form. However, other shapes of the locking elements 70 are also conceivable. To this end, the locking elements 70 may have the form of a cuboid where on one rectangular surface of the cuboid facing the one or more recesses 76, opposing edges of the surface are tapered or rounded. In FIG. 4, such locking elements 70 would preferably be oriented in such a manner that their rectangular surface with the tapered or rounded edges faces the tool shaft 36 and the one or more recesses 76, when the locking elements 70 are in their locking positions. Preferably, the rounded edges of the rectangular surface of the cuboid locking elements are opposite edges of the rectangular surface. Further preferred, the tapered or rounded edges face in opposite directions along the rotational axis 40 of the tool shaft 36, i.e., upwards and downwards in FIGS. 3 to 9, when the rotational axis 40 extends in a vertical direction.

The holding and guiding channels 74 may be formed according to the form of the locking elements 70, in order to hold and guide the locking elements 70. The radial recesses 76 may be formed according to the form of the locking elements 70, in order to receive at least part of the locking elements 70.

In contrast to the embodiment of FIG. 4, in the embodiment of FIG. 5, the locking elements 70 and the respective guiding and holding channels 74 are provided in the tool shaft 36 or its protruding element 68. Correspondingly, the radially extending recesses 76 are provided in the polishing pad 38 or its fastening section 52, respectively. For the rest, the embodiment of FIG. 5 may have the same characteristics as the embodiment of FIG. 4.

Further, in the embodiments of FIGS. 6 to 8, instead of the axial bore 66 provided in the fastening section 52 or the polishing pad 38, respectively, an axial bore 64 is provided in a distal end of the tool shaft 36. Furthermore, instead of the protruding element 68 of the tool shaft 36 configured to enter into the axial bore 66, the fastening section 52 of the polishing pad 38 comprises a protruding cylindrical pin 62 configured to be axially inserted into the axial bore 64 of the tool shaft 36. The distal end of the tool shaft 36 comprises a hollow cylindrical jacket 90 which radially delimits the axial recess or bore 64.

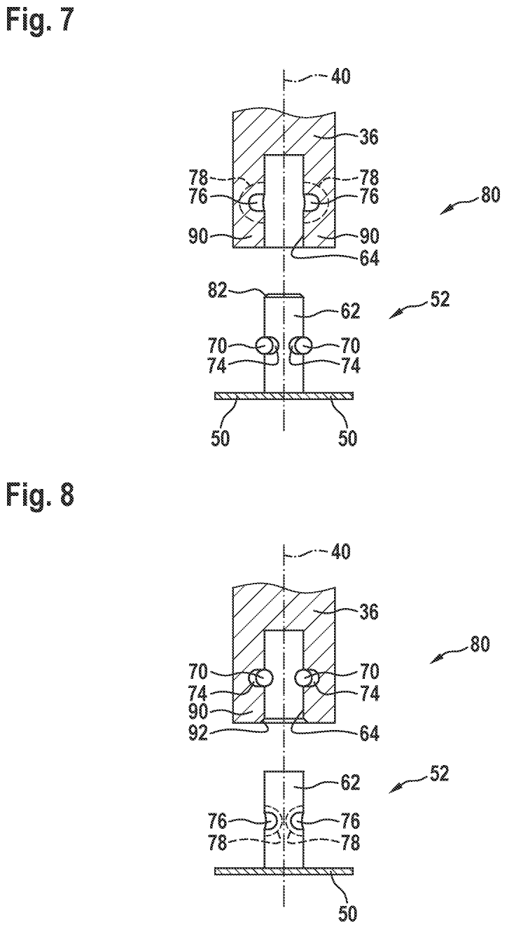

In the embodiment of FIG. 7, the locking elements 70 and the respective guiding and holding channels 74 are provided in the polishing pad 38 or an external circumferential surface of the cylindrical pin 62, respectively. Correspondingly, the radially extending recesses 76 are provided in the tool shaft 36, i.e., in an internal circumferential surface of the axial bore 64 or its hollow cylindrical jacket 90, respectively.

In contrast thereto, in the embodiment of FIG. 8, the locking elements 70 and the respective guiding and holding channels 74 are provided in the tool shaft 36, i.e., in an internal circumferential surface of the axial bore 64 or the hollow cylindrical jacket 90, respectively. Correspondingly, the radially extending recesses 76 are provided in the polishing pad 38 or an external circumferential surface of the cylindrical pin 62, respectively.

For the rest, the embodiments of FIGS. 6 to 8 may have the same or corresponding characteristics as the embodiments of FIGS. 3 to 5.

In the embodiment of FIG. 9, the polishing pad 38 is embodied as a double-sided polishing pad 38b. The axial recess or bore 66 for receiving a protruding element 68 of the tool shaft 36 is designed as a through hole accessible from both sides 56, 58 of the support structure 48 of the polishing pad 38b. No matter from which side the tool shaft 36 is attached to the polishing pad 38b, the same holding arrangement 80, in particular, the same radially extending one or more recesses 76 of the polishing pad 38, is used. For the rest, functioning of an attachment of the polishing pad 38b to the tool shaft 36 is similar to that described in respect to and shown in FIG. 5.

Of course, the double-sided polishing pad 38b could also have different types of axial holding arrangements 80, in particular corresponding to the embodiment described in respect to and shown in FIG. 4, where the locking elements 70 are provided in the polishing pad 38b, its support structure 48, or its fastening section 52, respectively, and the radially extending recesses 76 are provided in the tool shaft 36 or its protrusion element 68, respectively.

1. A hand-held power tool (10) comprising a tool housing (12) and a motor (24) located therein and a tool shaft (36) having a rotational axis (40) and actuated by the motor (24) when in operation in order to make the tool shaft (36) perform a rotational movement about its rotational axis (40), a distal end of the tool shaft (36) being accessible from outside the tool housing (12), and further comprising a working element (38) in the form of a polishing pad (38a; 38b) releasably attachable to the distal end of the tool shaft (36) from outside the tool housing (12) in an axial direction extending parallel to the rotational axis (40) of the tool shaft (36) and, after releasable attachment to the tool shaft (36), held in respect to the tool shaft (36) by means of an axial holding arrangement (80),
characterized in that the axial holding arrangement (80) comprises:
a first element (36; 38) constituted by one of the following elements, the polishing pad (38a; 38b) and the tool shaft (36), and a second element (38; 36) constituted by the other one of the elements, the polishing pad (38a; 38b) and the tool shaft (36), and
at least one locking element (70) assigned to the first element (36; 38) movably in a radial direction between a retracted position, in which the at least one locking element (70) is retracted in the first element (36; 38), and a locking position, in which the at least one locking element (70) protrudes from the first element (36; 38) radially towards the second element (38; 36),
at least one radial recess (76) assigned to the second element (38; 36) and having a radial extension, the at least one radial recess (76) being configured to receive part of the at least one locking element (70) when in its locking position after releasable attachment of the polishing pad (38a; 38b) to the tool shaft (36),
wherein at least one of the following elements, the at least one locking element (70) and the second element (38; 36) in and/or around the at least one radial recess (76), comprises a magnetic material, and the at least one other of the elements, the at least one locking element (70) and the second element (38; 36) in and/or around the at least one radial recess (76), comprises a magnetic material or a ferromagnetic material, so that the at least one locking element (70) is automatically moved and held in its locking position and in the at least one radial recess (76) by means of magnetic force after attachment of the polishing pad (38a; 38b) to the tool shaft (36), thereby engaging with the at least one radial recess (76) and holding the polishing pad (38a; 38b) in respect to the tool shaft (36) in the axial direction.

2. A hand-held power tool (10) according to claim 1, wherein the first element is the tool shaft (36) and the second element is the polishing pad (38a; 38b).

3. A hand-held power tool (10) according to claim 1, wherein the first element is the polishing pad (38a; 38b) and the second element is the tool shaft (36).

4. A hand-held power tool (10) according to claim 2, wherein the first element (36; 38) has an axially extending bore (64, 66) configured to receive a cylindrical pin (62; 68) of the second element (38; 36) after attachment of the polishing pad (38a; 38b) to the tool shaft (36), and the at least one locking element (70) is held in a hollow cylindrical jacket (72, 90) radially delimiting the axial bore (64, 66).

5. A hand-held power tool (10) according to claim 4, wherein the second element (38; 36) has a cylindrical pin (62; 68) configured to be inserted into the axial bore (64, 68) after attachment of the polishing pad (38a; 38b) to the tool shaft (36), and the at least one radial recess (76) is provided in an external circumferential surface of the cylindrical pin (62, 68).

6. A hand-held power tool (10) according to claim 2, wherein the first element (36; 38) has a cylindrical pin (62, 68) configured to be inserted into an axial bore (64, 68) of the second element (38; 36) after attachment of the polishing pad (38a; 38b) to the tool shaft (36), and the at least one locking element (70) is held in an external circumferential surface of the cylindrical pin (62, 68).

7. A hand-held power tool (10) according to claim 6, wherein the second element (38; 36) has an axially extending bore (64, 66) configured to receive the cylindrical pin (62; 68) of the first element (36; 38) after attachment of the polishing pad (38a; 38b) to the tool shaft (36) and the at least one radial recess (76) is provided on an internal circumferential surface of a hollow cylindrical jacket (72, 90) radially delimiting the axial bore (64, 66).

8. A hand-held power tool (10) according to claim 4, wherein at least one of a distal end of the cylindrical pin (62, 68) and/or an outer edge delimiting an entry hole into the axial bore (64, 66) has a tapered or rounded form (82, 92) in order to facilitate insertion of the cylindrical pin (62, 68) into the axial bore (64, 66) and to facilitate automatically pushing the at least one locking element (70) in a radial direction into its retracted position during insertion of the cylindrical pin (62, 68) into of the axial bore (64, 66).

9. A hand-held power tool (10) according to claim 4, wherein the axial bore (64, 66) and the respective cylindrical pin (62, 68) each have an axially extending section (84) with a corresponding cross-sectional surface without rotational symmetry, the sections (84) configured to mechanically engage with each other after attachment of the polishing pad (38a; 38b) to the tool shaft (36), thereby permitting the transmission of torque from the tool shaft (36) to the polishing pad (38a; 38b) during operation of the motor (24) of the power tool (10).

10. A hand-held power tool (10) according to claim 1, wherein a distal end surface (86) of the at least one locking element (70) facing the second element (38; 36) after attachment of the polishing pad (38a; 38b) to the tool shaft (36), and/or an outer edge (88) delimiting an entry hole into the at least one radial recess (76) facing the first element (36; 38) after attachment of the polishing pad (38a; 38b) to the tool shaft (36), has a tapered or rounded form in order to facilitate automatically pushing the at least one locking element (70) in a radial direction into its retracted position during detachment of the polishing pad (38a; 38b) from the tool shaft (36).

11. A hand-held power tool (10) according to claim 1, wherein the at least one locking element (70) and the at least one radial recess (76) are correspondingly shaped at least in those sections with which they engage with each other in the locking position of the at least one locking element (70).

12. A hand-held power tool (10) according to claim 1, wherein at least two locking elements (70) are equidistantly positioned in a circumferential direction about the rotational axis (40) of the tool shaft (36), after attachment of the polishing pad (38a; 38b) to the tool shaft (36), and/or wherein the axial holding arrangement (80) comprises preferably at least three, particularly preferred at least four locking elements (70).

13. A hand-held power tool (10) according to claim 1, wherein the axial holding arrangement (80) comprises the same number of one or more radial recesses (76) as there are locking elements (70) provided in the axial holding arrangement (80), or wherein the axial holding arrangement (80) comprises a single annularly shaped radial recess (76) configured to receive one locking element (70) or all the locking elements (70) in their locking positions.

14. A hand-held power tool (10) according to claim 1, wherein the polishing pad (38a; 38b) is configured as a double-sided polishing pad (38b) having two opposing sides (56, 58) and releasably attachable to the tool shaft (36) with either of its sides (56, 58) from outside the tool housing (12) in an axial direction parallel to the rotational axis (40) of the tool shaft (36), or wherein the polishing pad (38a; 38b) is configured as a single-sided polishing pad (38a) having two opposing sides (56, 58) and releasably attachable to the tool shaft (36) with only one of its sides (56) from outside the tool housing (12) in an axial direction parallel to the rotational axis (40) of the tool shaft (36).

15. An axial holding arrangement (80) for holding a polishing pad (38a; 38b) of a hand-held power tool (10) in respect to a tool shaft (36) of the power tool (10) in an axial direction extending parallel to a rotational axis (40) of the tool shaft (36), after releasable attachment of the polishing pad (38a; 38b) to a distal end of the tool shaft (36) in the axial direction,
characterized in that the axial holding arrangement (80) comprises
a first element (36; 38) constituted by one of the following elements, the polishing pad (38a; 38b) and the tool shaft (36), and a second element (38; 36) constituted by the other one of the elements, the polishing pad (38a; 38b) and the tool shaft (36), and
at least one locking element (70) assigned to the first element (36; 38) movably in a radial direction between a retracted position, in which the at least one locking element (70) is retracted in the first element (36; 38), and a locking position, in which the at least one locking element (70) protrudes from the first element (36; 38) radially towards the second element (38; 36),
at least one radial recess (76) assigned to the second element (38; 36), the at least one radial recess (76) being configured to receive at least part of the at least one locking element (70) when in its locking position and after attachment of the polishing pad (38a; 38b) to the tool shaft (36),
wherein at least one of the following elements, the at least one locking element (70) and at least a part of the second element (38; 36) in and/or around the at least one radial recess (76), comprises a magnetic material and the at least one other of the elements, the at least one locking element (70) and the second element (38; 36) in and/or around the at least one radial recess (76), comprises a magnetic material or a ferromagnetic material, so that the at least one locking element (70) is automatically moved into and held in its locking position and in the at least one radial recess (76) by magnetic force after attachment of the polishing pad (38a; 38b) to the tool shaft (36), thereby engaging with the at least one radial recess (76) and holding the polishing pad (38a; 38b) in respect to the tool shaft (36) in the axial direction.

16. A polishing pad (38a; 38b) of a hand-held power tool (10), the polishing pad (38a; 38b) configured for releasable attachment to a distal end of a tool shaft (36) of the power tool (10) in an axial direction extending parallel to a rotational axis (40) of the tool shaft (36) and further configured to be held in respect to the tool shaft (36) in the axial direction by means of an axial holding arrangement (80), after releasable attachment of the polishing pad (38a; 38b) to the tool shaft (36) in the axial direction,
characterized in that the polishing pad (38a; 38b) comprises:
a first element (36; 38), wherein a second element (38; 36) makes part of the tool shaft (36), or a second element (38; 36), wherein a first element (36; 38) makes part of the tool shaft (36), and
at least one locking element (70) assigned to the first element (36; 38) movably in a radial direction between a retracted position, in which the at least one locking element (70) is retracted in the first element (36; 38), and a locking position, in which the at least one locking element (70) protrudes from the first element (36; 38) radially towards the second element (38; 36),
at least one radial recess (76) assigned to the second element (38; 36), the at least one radial recess (76) being configured to receive at least part of the at least one locking element (70) when in its locking position and after attachment of the polishing pad (38a; 38b) to the tool shaft (36),
wherein at least one of the following elements, the at least one locking element (70) and the second element (38; 36) in and/or around the at least one radial recess (76), comprise a magnetic material and the at least one other of the elements, the at least one locking element (70) and the second element (38; 36) in and/or around the at least one radial recess (76), comprises a magnetic material or a ferromagnetic material, so that the at least one locking element (70) is automatically held in its locking position and in the at least one radial recess (76) by means of magnetic force after attachment of the polishing pad (38a; 38b) to the tool shaft (36), thereby engaging with the at least one radial recess (76) and holding the polishing pad (38a; 38b) in respect to the tool shaft (36) in the axial direction.

17. The polishing pad (38a; 38b) according to claim 16, wherein the polishing pad (38a; 38b) is configured as a double-sided polishing pad (38b) having two opposing sides (56, 58) and releasably attachable to the tool shaft (36) with either of its sides (56, 58) from outside the tool housing (12) in an axial direction parallel to the rotational axis (40) of the tool shaft (36), or wherein the polishing pad (38a; 38b) is configured as a single-sided polishing pad (38a) having two opposing sides (56, 58) and releasably attachable to the tool shaft (36) with only one of its sides (56) from outside the tool housing (12) in an axial direction parallel to the rotational axis (40) of the tool shaft (36).

18. The hand-held power tool (10) according to claim 3, wherein the first element (36; 38) has an axially extending bore (64, 66) configured to receive a cylindrical pin (62; 68) of the second element (38; 36) after attachment of the polishing pad (38a; 38b) to the tool shaft (36), and the at least one locking element (70) is held in a hollow cylindrical jacket (72, 90) radially delimiting the axial bore (64, 66).

19. The hand-held power tool (10) according to claim 3, wherein the first element (36; 38) has a cylindrical pin (62, 68) configured to be inserted into an axial bore (64, 68) of the second element (38; 36) after attachment of the polishing pad (38a; 38b) to the tool shaft (36), and the at least one locking element (70) is held in an external circumferential surface of the cylindrical pin (62, 68).

20. The hand-held power tool (10) according to claim 6, wherein a distal end of the cylindrical pin (62, 68) and/or an outer edge delimiting an entry hole into the axial bore (64, 66) has a tapered or rounded form (82, 92) in order to facilitate insertion of the cylindrical pin (62, 68) into the axial bore (64, 66) and/or to facilitate automatically pushing the at least one locking element (70) in a radial direction into its retracted position during insertion of the cylindrical pin (62, 68) into of the axial bore (64, 66).

21. The hand-held power tool (10) according to claim 6, wherein a distal end of the cylindrical pin (62, 68) and/or an outer edge delimiting an entry hole into the axial bore (64, 66) has a tapered or rounded form (82, 92) in order to facilitate insertion of the cylindrical pin (62, 68) into the axial bore (64, 66) and/or to facilitate automatically pushing the at least one locking element (70) in a radial direction into its retracted position during insertion of the cylindrical pin (62, 68) into of the axial bore (64, 66).

22. The hand-held power tool (10) according to claim 6, wherein the axial bore (64, 66) and the respective cylindrical pin (62, 68) each have an axially extending section (84) with a corresponding cross-sectional surface without rotational symmetry, the sections (84) configured to mechanically engage with each other after attachment of the polishing pad (38a; 38b) to the tool shaft (36), thereby permitting the transmission of torque from the tool shaft (36) to the polishing pad (38a; 38b) during operation of the motor (24) of the power tool (10).
